(19) United States
(12) Patent Application Publication
(10) Pub. No.: US 2003/0044662 A1
(43) Pub. Date: Mar. 6, 2003

(54) Method and apparatus for thermal management in a fuel cell system

(75) Inventor: Michael M. Walsh, Fairfield, CT (US)

Correspondence Address: FRED PRUNER - TROP, PRUNER, HU P.C., 8554 KATY FREEWAY, SUITE 100, HOUSTON, TX, 77024, US

(73) Assignee: Plug Power Inc., Latham, NY

(21) Appl. No.: 10/232,296

(22) Filed: Aug. 30, 2002

Related U.S. Application Data
(60) Provisional application No. 60/316,498, filed on Aug. 31, 2001.

(51) Int. Cl. H01M 8/04

(52) U.S. Cl. 429/26; 429/24; 429/13

(57) ABSTRACT

In one aspect, the invention provides a method and apparatus for thermal management in a fuel cell system. The fuel cell system includes a fuel cell or a fuel cell stack, and a coolant loop to remove heat from the stack. The coolant loop includes a radiator to remove heat from the coolant loop. The coolant loop also includes a liquid-to-liquid heat exchanger that can be used to remove heat form the coolant loop. The coolant from the coolant loop flows through a first side of the heat exchanger. The second side of the heat exchanger is not used by the fuel cell system, but rather is made available to systems outside the fuel cell system, which can circulate a fluid through the heat exchanger to heat the fluid.

### CROSS REFERENCE TO RELATED APPLICATIONS

This application claims priority under 35 USC 119(e) from U.S. Provisional Application No. 60/316,498, filed Aug. 31, 2001, naming Walsh as inventor, and titled “METHOD AND APPARATUS FOR THERMAL MANAGEMENT IN A FUEL CELL SYSTEM.” That application is incorporated herein by reference in its entirety and for all purposes.

### BACKGROUND

The invention generally relates to methods and apparatus for thermal management in a fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ (1)

at the anode of the cell, and

O₂+4H⁺+4e⁻→2H₂O (2)

at the cathode of the cell.

A typical fuel cell has a terminal voltage of up to about one volt DC.

For purposes of producing much larger voltages, multiple fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow field plates (graphite composite or metal plates, as examples) that are stacked one on top of the other. The plates may include various surface flow field channels and orifices to, as examples, route the reactants and products through the fuel cell stack. The flow field plates are generally molded, stamped or machined from materials including carbon composites, plastics and metal alloys. A PEM is sandwiched between each anode and cathode flow field plate. Electrically conductive gas diffusion layers (GDLs) may be located on each side of each PEM to act as a gas diffusion media and in some cases to provide a support for the fuel cell catalysts. In this manner, reactant gases from each side of the PEM may pass along the flow field channels and diffuse through the GDLs to reach the PEM. The GDL's generally comprise either a paper or cloth based on carbon fibers. The PEM and its adjacent pair of catalyst layers are often referred to as a membrane electrode assembly (MEA). An MEA sandwiched by adjacent GDL layers is often referred to as a membrane electrode unit (MEU), or also as an MEA. Common membrane materials include Nafion™, Gore Select™, sulphonated fluorocarbon polymers, and other materials such as polybenzimidazole and polyether ether ketone. Various suitable catalyst formulations are also known in the art, and are generally platinum-based.

A fuel cell system may include a fuel processor that converts a hydrocarbon (natural gas or propane, as examples) into a fuel flow for the fuel cell stack. For a given output power of the fuel cell stack, the fuel flow to the stack must satisfy the appropriate stoichiometric ratios governed by the equations listed above. Thus, a controller of the fuel cell system may monitor the output power of the stack and based on the monitored output power, estimate the fuel flow to satisfy the appropriate stoichiometric ratios. In this manner, the controller regulates the fuel processor to produce this flow, and in response to the controller detecting a change in the output power, the controller estimates a new rate of fuel flow and controls the fuel processor accordingly.

The fuel cell system may provide power to a load, such as a load that is formed from residential appliances and electrical devices that may be selectively turned on and off to vary the power that is demanded by the load. Thus, the load may not be constant, but rather the power that is consumed by the load may vary over time and abruptly change in steps. For example, if the fuel cell system provides power to a house, different appliances/electrical devices of the house may be turned on and off at different times to cause the load to vary in a stepwise fashion over time. Fuel cell systems adapted to accommodate variable loads are sometimes referred to as “load following” systems.

Fuel cell systems generally include various sources of waste heat, such as from fuel processing systems, the fuel cell stack itself, exhaust gas oxidizers, etc. In particular, the exhaust from a fuel cell is generally oxidized to remove trace amounts of unreacted fuels before it is exhausted to ambient. Such exhaust is generally hot and saturated with water vapor from the fuel cell system and from combustion of combustible gas components in the exhaust. For a variety of reasons, it may be desirable to recover such waste heat from a fuel cell system. As an example, if heat from a fuel cell system can be used to replace or supplement an external system that uses fuel to produce heat (e.g., a furnace or boiler), the combined efficiency of the systems may be increased. Also, where heat is recovered from a fuel cell exhaust stream, other benefits of waste heat recovery may include the recovery of water (e.g., to be reused in the system to humidify reactants or to hydrate the fuel cell membrane), since water will condense from a saturated exhaust stream as it is cooled. It may be further desirable to manage waste heat in a fuel cell system to provide improved control over system operating temperatures, and for a variety of other reasons that will be apparent to those skilled in the art.

There is thus a continuing need for fuel cell system design and algorithm improvements associated with thermal management to address factors including the foregoing.

### SUMMARY

The invention provides a thermal management system and related methods of operation for a fuel cell system. In one sense, the invention provides a method and apparatus for thermal management in a fuel cell system. The fuel cell system includes a fuel cell or a fuel cell stack, and a coolant loop to remove heat from the stack. The coolant loop includes a radiator to remove heat from the coolant loop. The coolant loop also includes a liquid-to-liquid heat exchanger that can be used to remove heat form the coolant loop. The coolant from the coolant loop flows through a first side of the heat exchanger. The second side of the heat exchanger is not used by the fuel cell system, but rather is made available to systems outside the fuel cell system, which can circulate a fluid through the heat exchanger to heat the fluid.

When the second side of the heat exchanger is not in use, the radiator functions to remove the necessary amount of heat from the coolant to keep the fuel cell stack at a desired temperature. The controller of the fuel cell system controls the operation of the radiator, but is not associated with the operation of the heat exchanger. The control of the fluid flowed through the second side of the heat exchanger is maintained independently by a system external to the fuel cell system that is associated with the use of the fluid. As an example, the fuel cell system can function as part of a domestic combined heat and power (CHP) system where the fuel cell is used to provide a residence or building with power, and a domestic hot water system circulates a water loop through the second side of the heat exchanger to heat the water, which is then provided to the residence or building.

Such a system provides an advantage in that the control circuitry and software for the fuel cell system can be the same for systems utilizing the liquid-to-liquid heat exchanger (also referred to as the CHP heat exchanger) as it is for systems not utilizing such an arrangement (e.g., non-CHP systems). For example, the effect of not utilizing the CHP heat exchanger or of not having one is simply that the radiator will be operated more frequently or at a higher rate since all of the excess heat from the coolant must be removed from the radiator.

In some embodiments, CHP heat exchanger is plumbed within the fuel cell system so that the inlet and outlet to the second side of the CHP heat exchanger are located along a portion of the outside enclosure of the fuel cell system. For example, the fuel cell system has an enclosure with two external connectors (e.g., threaded or quick connect varieties) for hooking the fluid loop of an outside system (e.g., domestic hot water system) to the second side of the CHP heat exchanger. This provides an advantage in that the outside system can be hooked up to the fuel cell system without having to disassemble the fuel cell system enclosure.

In some embodiments, the CHP heat exchanger may be a liquid-togas heat exchanger, and the fluid flowed through the second side of the heat exchanger may be a gas. For example, air can flowed through the second side of the heat exchanger to provide hot air to a residence or building or some other application. It will be appreciated that the terms liquid-to-liquid heat exchanger and liquid-to-gas heat exchanger are used herein in a functional sense, and are not intended as structurally limiting. For example, in some cases, the same heat exchanger can be used to transfer heat from the coolant to either of a liquid or gas stream. In other embodiments, the particular design of the heat exchanger may be tailored to a particular purpose.

In some embodiments, the coolant loop of the fuel cell system further includes a mechanism for preventing the CHP heat exchanger from cooling the fuel cell system coolant below a desired temperature threshold. As an example, for a fuel cell stack operated at 60-70° C., it may be desirable to keep the fuel cell system coolant at a temperature above 60° C. Thus, a thermostat may be used in the fuel cell coolant loop to bypass the CHP heat exchanger when the coolant temperature falls below 60° C., or some other predetermined threshold. In place of a thermostat, other arrangements may also be adapted for this purpose. For example, the coolant temperature may be monitored by a controller that actuates a three-way bypass valve or other valve arrangement to bypass the CHP heat exchanger. In some embodiments where a fan is associated with the radiator, the controller may react by turning off the fan.

In still other embodiments where the coolant temperature is maintained above a desired level, the temperature of the coolant is monitored by the external system associated with the fluid flowed through the second side of the CHP heat exchanger. If the coolant temperature is below a desired level, the external system can reduce the flow of the fluid through the second side of the CHP heat exchanger.

In another aspect of the invention, a fuel cell thermal management system is provided wherein a coolant conduit is adapted to remove heat from a fuel cell stack. The system includes a pump to circulate a coolant through the coolant conduit, and a radiator in fluid communication with the coolant conduit. A heat exchanger is also provided, having a first conduit and a second conduit. The first conduit is in fluid communication with the coolant conduit, and the second conduit has an inlet and an outlet, and wherein each of the inlet and outlet are adapted to receive a conduit coupling assembly.

In another aspect of the invention, a system includes a fuel cell stack, a coolant loop adapted to remove heat from the stack, a radiator adapted to remove heat from the coolant loop, and a heat exchanger adapted to remove heat from the coolant loop. The coolant in the coolant loop flows through a first conduit of the liquid-to-liquid heat exchanger. A heat transfer fluid flows through a second conduit of the liquid-to-liquid heat exchanger, and transfers heat to an application external to the fuel cell system.

In another aspect of the invention, a method is provided of regulating the temperature of a coolant in a fuel cell system, including at least the following steps: heating a coolant with heat from at least one of a fuel cell stack and a fuel processor; operating a radiator to lower the temperature of the coolant when the temperature is above a predetermined threshold; flowing the coolant through a first side of a liquid-to-liquid heat exchanger; flowing a heat transfer fluid through a second side of the liquid-to-liquid heat exchanger; heating the heat transfer fluid with heat from the coolant; and flowing the heat transfer fluid to a vessel external to the fuel cell system.

In another aspect of the invention, a fuel cell thermal management system is provided that includes a fuel cell stack and a coolant conduit containing a coolant adapted to remove heat from the stack. A pump is provided to circulate the coolant through the coolant conduit, and a radiator system is provided to remove heat from the coolant. The radiator system includes a fan adapted to circulate air through a radiator through which the coolant is circulated. A control circuit is provided to actuate the fan when a temperature of the coolant is above a predetermined threshold. The control circuit is adapted to vary a flow of the coolant through the stack in order to maintain a temperature of the stack below a predetermined threshold. A liquid-to-liquid heat exchanger is provided to remove heat from the coolant loop. The coolant flows through a first conduit of the liquid-to-liquid heat exchanger. A heat transfer fluid flows through a second conduit of the liquid-to-liquid heat exchanger, and serves to transfer heat to an application external to the fuel cell system.

In one aspect, a system is provided that includes a fuel cell, a coolant and a coolant circuit. The coolant circuit refers to a flow path of coolant that is circulated through the system. A pump is adapted to flow the coolant through the coolant circuit. The coolant circuit is coupled to the fuel cell and adapted to circulate the coolant through the fuel cell. A radiator is coupled to the coolant circuit, and the coolant circuit is adapted to circulate the coolant through the radiator.

A heat exchanger can be provided that has a first conduit and a second conduit (e.g., the heat exchanger is adapted to transfer heat between different fluid flows in each of the conduits). The first conduit is coupled to the coolant circuit, and the coolant circuit is adapted to circulate the coolant through the first conduit. The second conduit has an inlet and an outlet, and each of the inlet and outlet are adapted to receive a removable couple (e.g., a threaded pipe fitting, a spring actuated “quick connect” fitting, etc.). In the context of this invention, the term “coupled” refers to any direct or indirect connection. For example, in the case of an indirect connection between two components, the connection may include an intermediate connection to a third component, etc.

In some embodiments, systems include a fan adapted to flow air across a surface of the radiator when the fan is actuated. A control circuit is coupled to the fan and the pump. The control circuit refers to an electrical circuit adapted to monitor and control the system, either through manual user input, or automatically as in the case of a programmable control circuit. A first temperature sensor (e.g., a thermocouple or resistance temperature device) is coupled to the control circuit and the coolant circuit, the sensor being adapted to indicate to the control circuit a temperature of the coolant circuit. The control circuit is adapted to actuate the fan when the temperature of the coolant circuit is above a predetermined threshold. In one possible example, the fuel cell is a PEM fuel cell operating at a temperature of less than 85° C., and the predetermined threshold is 75° C. In other embodiments, other fuel cell systems can be used, such as a PEM fuel cell operating at a temperature in the range of 100-200° C. (e.g., utilizing a PBI membrane).

Some embodiments may include a second temperature sensor (e.g., a thermocouple or resistance temperature device) coupled to the control circuit and the fuel cell, where the thermocouple is adapted to indicate to the control circuit a temperature of the fuel cell. The control circuit can be adapted to vary an output of the pump to maintain the temperature of the fuel cell below a predetermined threshold (e.g., by increasing the coolant flow through the fuel cell).

In some embodiments, a heat transfer fluid can be provided in the second conduit, which is circulated from the inlet to the outlet to remove heat from the heat exchanger. A first valve and a first bypass circuit can be provided, wherein the first valve is coupled to the control circuit, wherein the first bypass circuit is adapted to bypass the coolant from the first conduit when the first valve is actuated, and wherein the control circuit is adapted to actuate the first valve to reduce an amount of heat transferred from the first conduit to the second conduit. The first and second valves can be solenoid or pressure driven, as examples. The first and second valves can also be of a type that are either fully open or fully shut, or of a type that can be opened to a varying degree.

Some embodiments may further include a second valve and a second bypass circuit, wherein the second valve is coupled to the control circuit, wherein the second bypass circuit is adapted to bypass the coolant from the first conduit when the second valve is actuated, and wherein the control circuit is adapted to actuate the second valve to reduce an amount of heat transferred from the coolant circuit to the radiator. A bypass circuit refers to a flow path around a component that is bypassed. For example, it may be desirable to prevent the coolant temperature from falling below the operating temperature of the fuel cell. To achieve this, the coolant flow to the radiator or heat exchanger may be bypassed to avoid transferring heat to these components.

In some embodiments, an inlet removable couple is mounted onto a housing of the system, and an outlet removable couple is mounted to the housing of the system. The inlet is a third conduit connecting the inlet removable couple to the second conduit, and the outlet is a fourth conduit connecting the outlet removable couple to the second conduit. Thus a system is provided that can be easily coupled to a heat transfer fluid from an external source, such as a hot water tank, that is circulated through the heat exchanger within the fuel cell system. Since the removable couplings are provided on the system housing, such an interface can be achieved without needing to disassemble the system housing to access the heat exchanger.

In another aspect, the invention provides a fuel cell system having a fuel cell, a coolant (e.g., deionized water or some other dielectric fluid such as Therminol™ or deionized glycol), and a coolant circuit. A pump is adapted to flow the coolant through the coolant circuit. The coolant circuit is coupled to the fuel cell and adapted to remove heat from the fuel cell. A radiator is coupled to the coolant circuit and adapted to remove heat from the coolant circuit. A heat exchanger is provided that has a first conduit and a second conduit, wherein the first conduit is coupled to the coolant circuit and adapted to transfer heat from the coolant to the second conduit. A heat transfer fluid (e.g., water) is provided in the second conduit, the heat transfer fluid being circulated from the inlet to the outlet, wherein the heat transfer fluid transfers heat to a heat sink external to the fuel cell system. In this context, a “heat sink” refers to any mass to which heat is transferred, for example, a body of water at a lower temperature than the heat transfer fluid.

In another aspect, a method is provided for regulating a coolant temperature in a fuel cell system, including at least the following steps: (1) heating a coolant with heat from at least one of a fuel cell and a fuel processor; (2) flowing the coolant through a radiator; (3) flowing the coolant through a first side of a heat exchanger; (4) flowing a heat transfer fluid through a second side of the heat exchanger; (5) heating the heat transfer fluid with heat from the coolant; and (6) flowing the heat transfer fluid to a heat sink external to the fuel cell system to remove heat from the heat transfer fluid.

Some embodiments may also include regulating the flow of heat transfer fluid through the second side of the heat exchanger to reduce the heat transferred from the first side to the second side when the temperature of the coolant is below a predetermined threshold (e.g., the operating temperature of the fuel cell as measured at the outlet of the fuel cell). Other embodiments may include flowing air across a surface of the radiator to lower the temperature of the coolant when the temperature is above a predetermined threshold (e.g., the operating temperature of the fuel cell as measured at the inlet of the fuel cell), bypassing the coolant from the radiator when the temperature is below a predetermined threshold, or bypassing the coolant from the heat exchanger when the temperature is below a predetermined threshold.

It will be appreciated that the coolant temperature may vary depending on its location in the coolant circuit, and a particular desired temperature threshold may vary according to where a temperature measurement of the coolant is taken.

In another aspect, the invention provides a fuel cell thermal management system. The system includes a fuel cell, a coolant, and a coolant circuit. A pump is adapted to flow the coolant through the coolant circuit. The coolant circuit is coupled to the fuel cell and adapted to remove heat from the fuel cell. A radiator is coupled to the coolant circuit and adapted to remove heat from the coolant circuit. A fan is adapted to flow air across a surface of the radiator when the fan is actuated. A control circuit is coupled to the fan and the pump. A thermocouple is coupled to the control circuit and the coolant circuit, the thermocouple being adapted to indicate to the control circuit a temperature of the coolant circuit. The control circuit is adapted to actuate the fan when the temperature of the coolant circuit is above a predetermined threshold. A heat exchanger has a first conduit and a second conduit, wherein the first conduit is coupled to the coolant circuit and adapted to transfer heat from the coolant circuit to the second conduit. A heat transfer fluid is provided in the second conduit, wherein the heat transfer fluid transfers heat to a heat sink external to the fuel cell system.

In some embodiments, the heat sink can be a hot water tank, a heat exchanger adapted to transfer heat to a vessel containing water, or a heat exchanger adapted to transfer heat to a body of air enclosed in a building, as examples.

In another aspect, the invention provides a method of thermal management for a fuel cell system, including at least the following steps: (1) heating a coolant with heat from at least one of a fuel cell stack and a fuel processor; (2) flowing the coolant through a first side of a heat exchanger; (3) flowing a heat transfer fluid through a second side of the heat exchanger to remove a first amount of heat from the coolant, the first amount of heat being determined by a control circuit external to the fuel cell system; and (4) flowing the coolant through a radiator to lower the temperature of the coolant when the temperature is above a predetermined threshold. As examples, the control circuit can be a thermostat of a hot water tank or of an airspace in a building.

In some embodiments, methods can further include bypassing the coolant from the radiator when the temperature is below a predetermined threshold, or bypassing the coolant from the heat exchanger when the temperature is below a predetermined threshold.

Advantages and other features of the invention will become apparent from the following description, drawing and claims. It will be appreciated that various embodiments of the invention can include any of the features, aspects, and steps discussed herein, either alone or in combination.

### BRIEF DESCRIPTION OF THE DRAWINGS

FIG. 1 shows a schematic diagram of a fuel cell thermal management system in the prior art.

FIG. 2 shows a schematic diagram of a fuel cell thermal management system.

FIG. 3 shows a schematic diagram of a fuel cell thermal management system.

FIG. 4 shows a perspective view of a fuel cell system having external connectors associated with an internal thermal management system.

### DETAILED DESCRIPTION

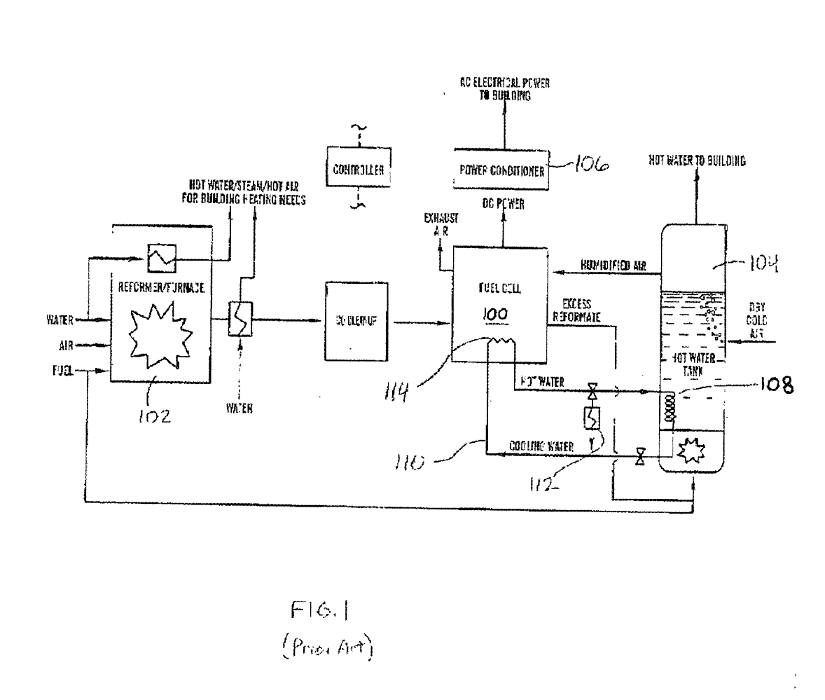

Referring to FIG. 1, a CHP fuel cell system is shown from the prior art (e.g., see U.S. Pat. No. 5,985,474). A fuel cell system 100 receives fuel from a reformer 102 and reacts the fuel with humidified air from a hot water tank 104. The fuel cell system 100 provides power to a building via power conditioner 106. The fuel cell system also provides heat to the water tank 104 via heat exchanger 108, which is located inside the water tank 104. A coolant is circulated through the fuel cell stack (indicated at 114) and the heat exchanger 108 via coolant loop 110. Unlike embodiments under the present invention, no radiator is provided, such that all excess heat is removed from the fuel cell system 100 via coolant loop 110. The temperature of the water tank 104 is regulated by the heat exchanger 112.

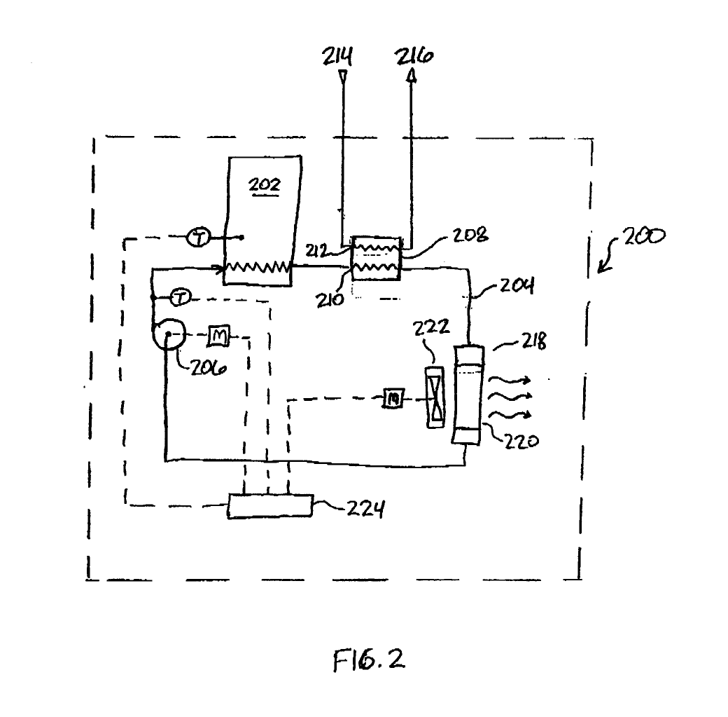

Referring to FIG. 2, a thermal management system 200 is provided for a fuel cell system. A fuel cell stack 202 is connected to a coolant loop 204. Pump 206 circulates a coolant through the stack 202 to remove excess heat. The coolant loop 204 includes a heat exchanger 208 to remove heat form the coolant. As an example, the heat exchanger 208 can be a plate type heat exchanger, a shell and tube type heat exchanger, etc. The coolant flows through a first conduit 210 of the heat exchanger 208. The first conduit is adapted to transfer heat to a fluid flowed through second conduit 212, having an inlet 214 and an outlet 216.

The coolant loop 204 includes a radiator system 218, that includes a heat exchanger 220 and a fan 222 adapted to blow air through the heat exchanger 220. In some systems, the output of the fan can be varied to control the amount of heat that is removed from the coolant in the radiator (e.g., to achieve a desired coolant temperature exhausted from the radiator 220. The system 200 also includes a controller 224 adapted to actuate the fan 222 and the pump 206. In the embodiment shown in FIG. 2, the controller is further adapted to measure the temperature of the stack 202, and the temperature of the coolant in the coolant loop 204 at a location between the pump 206 and the stack 202.

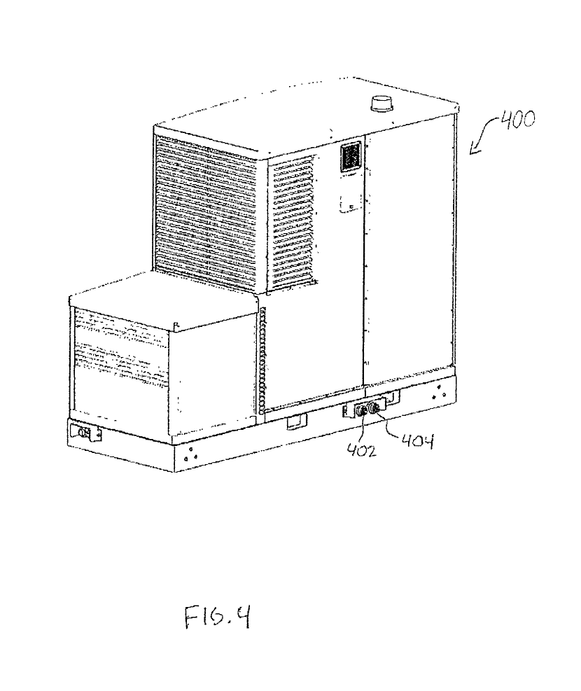

As previously described, the controller 224 maintains the temperature of the coolant in the coolant loop 204 above a predetermined threshold by operating the fan 222 associated with the radiator system 218. Some embodiments may include a bypass system for bypassing the coolant around the heat exchanger 208 to prevent the removal of too much heat from the coolant. Another system (not shown) that is external to system 200 independently regulates the flow of fluid through the second conduit 212 of heat exchanger 208. In some embodiments, the inlet 214 and outlet 216 associated with the second conduit 212 may be external connectors that are provided on the housing of a fuel cell system (see FIG. 4).

As previously discussed, a fuel processor is a device that converts a hydrocarbon fuel into hydrogen. In the example shown in FIG. 2, the coolant loop flows through fuel cell stack 202 and removes heat from the stack 202. In some embodiments, the coolant loop also flows through a fuel processor (not shown), or can serve to remove heat only from the fuel processor (e.g., the fuel cell has an independent coolant loop from the fuel processor). It will be appreciated that fuel processors generally operate at much higher temperatures than fuel cells, especially PEM fuel cells.

For example, the two reactions which are generally used to achieve covert a hydrocarbon into a reformate stream are shown in equations (3) and (4).

½O2+CH4-->2H2+CO (3)

H2O+CH4-->3H2+CO (4)

The reaction shown in equation (3) is sometimes referred to as catalytic partial oxidation (CPO). The reaction shown in equation (4) is generally referred to as steam reforming. Both reactions may be conducted at a temperature from about 600-1,100° C. in the presence of a catalyst such as nickel with amounts of a noble metal, such as cobalt, platinum, palladium, rhodium, ruthenium, iridium, and a support such as magnesia, magnesium aluminate, alumina, silica, zirconia, by themselves or in combination. Alternatively, reforming catalysts can also be a single metal, such as nickel or platinum, supported on a refractory carrier like magnesia, magnesium aluminate, alumina, silica, or zirconia, by themselves or in combination, or promoted by an alkali metal like potassium. As an example, a platinum wash-coated ceramic monolith may be used. As further examples, catalyst pellets may be used, which may be held in a flow-through reactor canister by screens. Catalyzed plate heat exchangers may also be used. Catalyzed shell and tube heat exchangers may also be used, for example, with tubes catalyzed either internally or externally.

A fuel processor may use either of these reactions separately, or both in combination. While the CPO reaction is exothermic, the steam reforming reaction is endothermic. Reactors utilizing both reactions to maintain a relative heat balance are sometimes referred to as autothermal (ATR) reactors (note that the terms CPO and ATR are sometimes used interchangeably). Also, it should be noted that fuel processors are sometimes generically referred to as reformers, and the fuel processor output gas is sometimes generically referred to as reformate, without respect to which reaction is employed.

As evident from equations (3) and (4), both reactions produce carbon monoxide (CO). Such CO is generally present in amounts greater than 10,000 ppm. Because of the high temperature at which the fuel processor is operated, this CO generally does not affect the catalysts in the fuel processor. However, if this reformate is passed to a fuel cell system operating at a lower temperature (e.g., less than 100° C.), the CO may poison the catalysts in the fuel cell by binding to catalyst sites, inhibiting the hydrogen in the cell from reacting. In such systems it is typically necessary to reduce CO levels to less than 100 ppm. For this reason the fuel processor may employ additional reactions and processes to reduce the CO that is produced. For example, two additional reactions that may be used to accomplish this objective are shown in equations (5) and (6). The reaction shown in equation (5) is generally referred to as the shift reaction, and the reaction shown in equation (6) is generally referred to as preferential oxidation (PROX).

CO+H2O-->H2+CO2 (5)

CO+½O-->CO2 (6)

Various catalysts and operating conditions are known for accomplishing the shift reaction. For example, the reaction may be conducted at a temperature from about 300-600° C. in the presence of various catalysts including ferric oxide, chromic and chromium oxides, iron silicide, supported platinum, supported palladium, and other supported platinum group metals, by themselves or in combination. Other catalysts and operating conditions are also known. Such systems operating in this temperature range are typically referred to as high temperature shift (HTS) systems.

The shift reaction may also be conducted at lower temperatures such as 100-300° C. in the presence of other catalysts such as copper supported on transition metal oxides like zirconia, zinc supported on transition metal oxides or refractory supports like silica or alumina, supported platinum, supported rhenium, supported palladium, supported rhodium and supported gold, by themselves or in combination. Combinations of copper with cerium or rare earth metals or ceria or rare earth metal oxides are also know to exhibit high catalytic activity. Such systems operating in this temperature range are typically referred to as low temperature shift (LTS) systems. LTS reactors often utilize catalyst pellets. Other catalysts and operating conditions are also known. In a practical sense, typically the shift reaction may be used to lower CO levels to about 3,000-10,000 ppm, although as an equilibrium reaction it may be theoretically possible to drive CO levels even lower.

The PROX reaction may also be used. The PROX reaction is generally conducted at lower temperatures than the shift reaction, such as 100-200° C. Like the CPO reaction, the PROX reaction can also be conducted in the presence of an oxidation catalyst such as platinum. The PROX reaction can typically achieve CO levels less than 100 ppm. Other non-catalytic CO reduction and reformate purification methods are also known, such as membrane filtration and pressure swing adsorption systems.

In various embodiments, the coolant loop 204 can be routed to maintain the temperatures associated with any of these reactions. As an example, the coolant loop 204 may be routed to a relatively low temperature component such as the fuel cell stack, where it is heated, and may then be routed to successively higher temperature components (e.g., in the fuel processor) before being routed to the radiator 220 or heat exchanger 208.

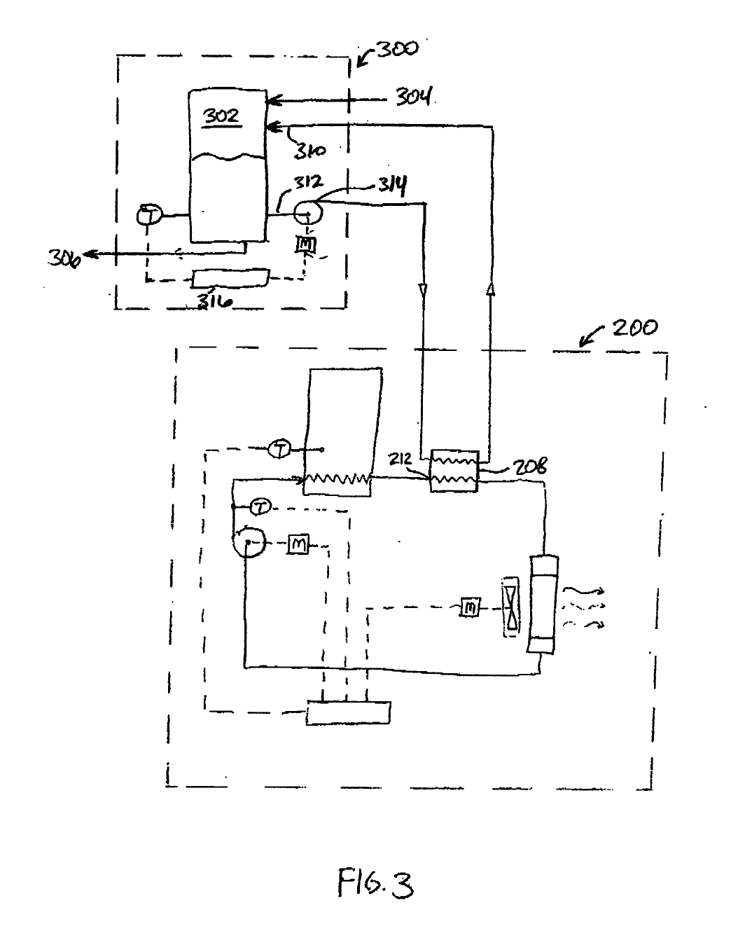

The forgoing example can also be referred to in terms of a method for regulating a coolant temperature in a fuel cell system. In a first step, the coolant circuit 204 is heated with heat from at least one of a fuel cell 202 and a fuel processor. In a second step, a coolant is flowed through the radiator 220. In a third step, the coolant is flowed through a first side 210 of the heat exchanger 208. In a fourth step, a heat transfer fluid is flowed through a second side 212 of the heat exchanger 208. In a fifth step, the heat transfer fluid is heated with heat from the coolant circuit 204 (via heat exchanger 208). In a sixth step, the heat transfer fluid is flowed to a heat sink (e.g., 302 as shown in FIG. 3) external to the fuel cell system 200 to remove heat from the heat transfer fluid.

In this context, “external to the fuel cell system” refers to a heat sink located external to the fuel cell system housing (e.g., which can include the fuel cell as well as a fuel processor). For example, the fuel cell system could be located outside a building for the purpose of generating electrical power for the building. The waste heat from the system can be used to provide hot water to the building. In such a case, the heat sink may be a hot water tank located in the building (external to the fuel cell system). For example, hot water from the tank can be circulated from the tank through the heat exchanger in the fuel cell system. As another example, heat can be transferred from the heat exchanger in the fuel cell system to the hot water tank via a closed heat transfer loop that circulates a heat transfer fluid through a heat exchanger in the hot water tank. Other arrangements are possible.

Referring to FIG. 3, the system of FIG. 2 is shown integrated with an external system adapted to circulate a fluid through the second conduit 212 of the heat exchanger 208. The system 300 includes a water tank having an inlet 304 from a municipal water supply and an outlet 306 leading to a residence or a building (e.g., potable water supply or forced water radiator system). The water tank 302 also includes inlet 310 from system 200 and outlet 312 leading to system 200. The circulation of water between inlet 310 and outlet 312 is driven by pump 314, which is actuated by controller 316, which bases control of the pump 314 on the temperature of the tank 302. In some embodiments, the system 300 may further include a supplemental burner (not shown) to heat the water tank when heat from heat exchanger 208 is not available. Also, in some embodiments, the tank 302 may include a heat exchanger through which a fluid is circulated between inlet 310 and outlet 312. In this way, a closed fluid loop can serve to carry heat from system 200 to system 300.

Referring to FIG. 4, a housing of a fuel cell system 400 includes an inlet connector 402 and an outlet connector 404. Connectors 402 and 404 provide access and fluid communication to a heat exchanger within the housing 400 that can provide heat to a fluid circulated through the connectors 402 and 404. For example, such a heat exchanger 208 is discussed with respect to FIG. 2.

Further embodiments of the invention may include apparatus and methods based on any combination of the features and aspects described above.

While the invention has been disclosed with respect to a limited number of embodiments, those skilled in the art, having the benefit of this disclosure, will appreciate numerous modifications and variations therefrom. It is intended that the invention covers all such modifications and variations as fall within the true spirit and scope of the invention.

What is claimed is:

1. A fuel cell thermal management system, comprising:
a fuel cell, a coolant and a coolant circuit;
a pump adapted to flow the coolant through the coolant circuit, wherein the coolant circuit is coupled to the fuel cell and adapted to circulate the coolant through the fuel cell;
a radiator coupled to the coolant circuit, wherein the coolant circuit is adapted to circulate the coolant through the radiator;
a heat exchanger having a first conduit and a second conduit;
wherein the first conduit is coupled to the coolant circuit, wherein the coolant circuit is adapted to circulate the coolant through the first conduit; and
wherein the second conduit has an inlet and an outlet, and wherein each of the inlet and outlet are adapted to receive a removable couple.

2. The system of claim 1, further comprising:
a fan adapted to flow air across a surface of the radiator when the fan is actuated;
a control circuit coupled to the fan and the pump;
a first temperature sensor coupled to the control circuit and the coolant circuit, the temperature sensor being adapted to indicate to the control circuit a temperature of the coolant circuit; and
wherein the control circuit is adapted to actuate the fan when the temperature of the coolant circuit is above a predetermined threshold.

3. The system of claim 2, wherein the fuel cell is a PEM fuel cell operating at a temperature of less than 85° C., and the predetermined threshold is less than 75° C.

4. The system of claim 2, further comprising a second temperature sensor coupled to the control circuit and the fuel cell, the temperature sensor being adapted to indicate to the control circuit a temperature of the fuel cell; and
wherein the control circuit is adapted to vary an output of the pump to maintain the temperature of the fuel cell below a predetermined threshold.

5. The system of claim 2, further comprising:
a heat transfer fluid in the second conduit, the heat transfer fluid being circulated from the inlet to the outlet;
a first valve and a first bypass circuit; and
wherein the first valve is coupled to the control circuit, wherein the first bypass circuit is adapted to bypass the coolant from the first conduit when the first valve is actuated; and wherein the control circuit is adapted to actuate the first valve to reduce an amount of heat transferred from the first conduit to the second conduit.

6. The system of claim 2, further comprising:
a second valve and a second bypass circuit; and
wherein the second valve is coupled to the control circuit, wherein the second bypass circuit is adapted to bypass the coolant from the first conduit when the second valve is actuated; and wherein the control circuit is adapted to actuate the second valve to reduce an amount of heat transferred from the coolant circuit to the radiator.

7. The system of claim 2, wherein the control circuit is adapted to vary an output of the fan.

8. The system of claim 1, wherein the fuel cell is a PEM fuel cell operating at a temperature of less than 100° C.

9. The system of claim 1, wherein the fuel cell is a PEM fuel cell operating at a temperature in the range of 100-200° C.

10. The system of claim 1, wherein the heat exchanger is a plate type heat exchanger.

11. The system of claim 5, wherein the heat transfer fluid is water from a hot water tank.

12. The system of claim 1, wherein an inlet removable couple is mounted onto a housing of the system, wherein an outlet removable couple is mounted to the housing of the system, wherein the inlet is a third conduit connecting the inlet removable couple to the second conduit, wherein the outlet is a fourth conduit connecting the outlet removable couple to the second conduit.

13. The system of claim 1, wherein the removable couple is a threaded pipe fitting.

14. The system of claim 1, wherein the coolant is dielectric.

15. A fuel cell system, comprising:
a fuel cell, a coolant, and a coolant circuit;
a pump adapted to flow the coolant through the coolant circuit;
wherein the coolant circuit is coupled to the fuel cell and adapted to remove heat from the fuel cell;
a radiator coupled to the coolant circuit and adapted to remove heat from the coolant circuit;
a heat exchanger having a first conduit and a second conduit, wherein the first conduit is coupled to the coolant circuit and adapted to transfer heat from the coolant to the second conduit; and
a heat transfer fluid in the second conduit, the heat transfer fluid being circulated from the inlet to the outlet, wherein the heat transfer fluid transfers heat to a heat sink external to the fuel cell system.

16. The system of claim 15, further comprising:
a fan adapted to flow air across a surface of the radiator when the fan is actuated;
a control circuit coupled to the fan and the pump;
a first temperature sensor coupled to the control circuit and the coolant circuit, the temperature sensor being adapted to indicate to the control circuit a temperature of the coolant circuit; and
wherein the control circuit is adapted to actuate the fan when the temperature of the coolant circuit is above a predetermined threshold.

17. The system of claim 16, further comprising a second temperature sensor coupled to the control circuit and the fuel cell, the temperature sensor being adapted to indicate to the control circuit a temperature of the fuel cell; and
wherein the control circuit is adapted to vary an output of the pump in response to a signal from the second temperature sensor.

18. The system of claim 16, further comprising:
a first valve and a first bypass circuit; and
wherein the first valve is coupled to the control circuit, wherein the first bypass circuit is adapted to bypass the coolant from the first conduit when the first valve is actuated; and wherein the control circuit is adapted to actuate the first valve to reduce an amount of heat transferred from the first conduit to the second conduit.

19. The system of claim 15, further comprising:
a control circuit, a second valve and a second bypass circuit; and
wherein the second valve is coupled to the control circuit, wherein the second bypass circuit is adapted to bypass the coolant from the radiator when the second valve is actuated; and wherein the control circuit is adapted to actuate the second valve to reduce an amount of heat transferred from the coolant circuit to the radiator.

20. The system of claim 15, wherein the heat sink is a hot water tank.

21. The system of claim 15, wherein the heat sink is a heat exchanger adapted to transfer heat to a vessel containing water.

22. The system of claim 15, wherein the heat sink is a heat exchanger adapted to transfer heat to a body of air enclosed in a building.

23. A method of regulating a coolant temperature in a fuel cell system, comprising:
heating a coolant with heat from at least one of a fuel cell and a fuel processor;
flowing the coolant through a radiator;
flowing the coolant through a first side of a heat exchanger;
flowing a heat transfer fluid through a second side of the heat exchanger;
heating the heat transfer fluid with heat from the coolant; and
flowing the heat transfer fluid to a heat sink external to the fuel cell system to remove heat from the heat transfer fluid.

24. The method of claim 23, further comprising:
regulating the flow of heat transfer fluid through the second side of the heat exchanger to reduce the heat transferred from the first side to the second side when the temperature of the coolant is below a predetermined threshold.

25. The method of claim 23, further comprising:
flowing air across a surface of the radiator to lower the temperature of the coolant when the temperature is above a predetermined threshold.

26. The method of claim 23, further comprising:
bypassing the coolant from the radiator when the temperature is below a predetermined threshold.

27. The method of claim 23, further comprising:
bypassing the coolant from the heat exchanger when the temperature is below a predetermined threshold.

28. A fuel cell thermal management system, comprising:
a fuel cell, a coolant, and a coolant circuit;
a pump adapted to flow the coolant through the coolant circuit;
wherein the coolant circuit is coupled to the fuel cell and adapted to remove heat from the fuel cell;
a radiator coupled to the coolant circuit and adapted to remove heat from the coolant circuit;
a fan adapted to flow air across a surface of the radiator when the fan is actuated;
a control circuit coupled to the fan and the pump;
a temperature sensor coupled to the control circuit and the coolant circuit, the temperature sensor being adapted to indicate to the control circuit a temperature of the coolant circuit;
wherein the control circuit is adapted to actuate the fan when the temperature of the coolant circuit is above a predetermined threshold;
a heat exchanger having a first conduit and a second conduit, wherein the-first conduit is coupled to the coolant circuit and adapted to transfer heat from the coolant circuit to the second conduit; and
a heat transfer fluid in the second conduit, wherein the heat transfer fluid transfers heat to a heat sink external to the fuel cell system.

29. The system of claim 28, further comprising a second temperature sensor coupled to the control circuit and the fuel cell, the temperature sensor being adapted to indicate to the control circuit a temperature of the fuel cell; and
wherein the control circuit is adapted to vary an output of the pump in response to a signal from the second temperature sensor.

30. The system of claim 28, further comprising:
a first valve and a first bypass circuit; and
wherein the first valve is coupled to the control circuit, wherein the first bypass circuit is adapted to bypass the coolant from the first conduit when the first valve is actuated; and wherein the control circuit is adapted to actuate the first valve to vary an amount of heat transferred from the first conduit to the second conduit.

31. The system of claim 28, further comprising:
a second valve and a second bypass circuit; and
wherein the second valve is coupled to the control circuit, wherein the second bypass circuit is adapted to bypass the coolant from the radiator when the second valve is actuated; and wherein the control circuit is adapted to actuate the second valve to vary an amount of heat transferred from the coolant circuit to the radiator.

32. The system of claim 28, wherein the heat sink is a hot water tank.

33. The system of claim 28, wherein the heat sink is a heat exchanger adapted to transfer heat to a vessel containing water.

34. The system of claim 28, wherein the heat sink is a heat exchanger adapted to transfer heat to a body of air enclosed in a building.

35. A method of thermal management for a fuel cell system, comprising:
heating a coolant with heat from at least one of a fuel cell stack and a fuel processor;
flowing the coolant through a first side of a heat exchanger;
flowing a heat transfer fluid through a second side of the heat exchanger to remove a first amount of heat from the coolant, the first amount of heat being determined by a control circuit external to the fuel cell system; and
flowing the coolant through a radiator to lower the temperature of the coolant when the temperature is above a predetermined threshold.

36. The method of claim 35, wherein the control circuit is a thermostat of a hot water tank.

37. The method of claim 35, wherein the control circuit is a thermostat of an airspace in a building.

38. The method of claim 35, further comprising:
bypassing the coolant from the radiator when the temperature is below a predetermined threshold.

39. The method of claim 35, further comprising:
bypassing the coolant from the heat exchanger when the temperature is below a predetermined threshold.
